(19) United States
(12) Patent Application Publication
(10) Pub. No.: US 2026/0017711 A1
(43) Pub. Date: Jan. 15, 2026

(54) CASINO GAMING AUCTION SYSTEM

(71) Applicant: IGT, Las Vegas, NV (US)

(72) Inventors: Michael Russ, Graz (AT); Stefan Keilwert, St. Josef (AT); David Froy, Lakeville-Westmorland (CA); Soheil Latifi, Brampton (CA)

(21) Appl. No.: 18/770,970

(22) Filed: Jul. 12, 2024

(51) Int. Cl. G06Q 30/08; A63F 3/08; A63F 13/355; G07F 17/32

(52) U.S. Cl. CPC G06Q 30/08; A63F 3/081; A63F 13/355; G07F 17/3272

(57) ABSTRACT

Embodiments of the present disclosure are directed to conducting an auction among players and/or visitors in a gaming venue. Players in the casino or other gaming venue can voluntarily participate in the auction, from within the venue, such as through an Electronic Gaming Machine (EGM) or other gaming system they are playing, or from a mobile device connected to the casino or to a gaming device. Various gaming-related features, vouchers, prizes, products, etc. that are associated with the venue can be purchased by auction, among players being present in the casino venue, in real-time.

### BACKGROUND

The present disclosure is generally directed to electronic gaming and more particularly to conducting an auction among players and/or visitors in a gaming venue.

Often, visiting a casino, especially playing slots, is a solitary experience. The player plays the game, perhaps someone watches from behind, or perhaps the game streams gameplay. Sometimes, there are also tournament-like games or teamplay initiatives. However, these remain relatively rare.

Embodiments of the present disclosure are directed to conducting an auction among players and/or visitors in a gaming venue. According to one embodiment, a method for providing an auction in a gaming venue can comprise providing, to a plurality of gaming systems in the gaming venue, an electronic message indicating availability of an auction. An electronic message indicating participation in the auction by a plurality of players of electronic games executing on the plurality of gaming systems can be received from the plurality of gaming systems and the auction can be initiated. In some cases, each player of the plurality of players can first be authenticated. The auction can comprise a silent auction, a themed mystery auction, or other type of auction.

A plurality of electronic messages indicating bids from the plurality of players can be received from the plurality of gaming systems and a player of the plurality of players placing a highest bid at a close of the auction can be determined based on the received plurality of electronic messages indicating bids from the plurality of players. An auction prize can be provided to the player of the plurality of players placing the highest bid at a close of the auction. The auction prize can comprise an electronic game feature, a gaming venue event ticket, a Non-Fungible Token (NFT), a gaming venue-related benefit, or other award.

In some cases, an electronic message indicating availability of an auction can also be provided to a plurality of mobile devices within the gaming venue. In such cases, an electronic message indicating participation in the auction by users of the plurality of mobile devices can be received and a plurality of electronic messages indicating bids from the users of the plurality of mobile devices can be received from the plurality of mobile devices. Determining the player of the plurality of players placing the highest bid at the close of the auction based on the received plurality of electronic messages indicating bids from the plurality of players can further comprise determining the player of the plurality of players or user of the plurality of mobile devices placing the highest bid at the close of the auction based on the received plurality of electronic messages indicating bids from the plurality of players and the received plurality of electronic messages indicating bids from the users of the plurality of mobile devices.

According to another embodiment, a system can comprise a communication interface, a processor coupled with the communication interface, and a memory coupled with and readable by the processor, the memory can store therein a set of instructions which, when executed by the processor, causes the processor to provide, to a plurality of mobile devices within a gaming venue, an electronic message indicating availability of an auction, receive, from the plurality of mobile devices, an electronic message indicating participation in the auction by a plurality of user of the plurality of mobile devices, initiate the auction, receive, from the plurality of mobile devices, a plurality of electronic messages indicating bids from the users of the mobile devices, determine a user of the plurality of users placing a highest bid at a close of the auction based on the received plurality of electronic messages indicating bids from the users of the plurality of mobile devices, and provide an auction prize to the user of the plurality of users placing the highest bid at a close of the auction.

In some cases, the instructions can further cause the processor to provide the electronic message indicating availability of an auction to a plurality of gaming systems within the gaming venue, receive, from the plurality of gaming systems, an electronic message indicating participation in the auction by players of electronic games on the plurality of gaming systems, and receive, from the plurality of gaming systems, a plurality of electronic messages indicating bids from the players of the electronic games executing on the plurality of gaming systems, wherein determining the user of the plurality of users placing the highest bid at the close of the auction based on the received plurality of electronic messages indicating bids from the users of the plurality of mobile devices further comprises determining the player of the plurality of players or user of the plurality of mobile devices placing the highest bid at the close of the auction based on the received plurality of electronic messages indicating bids from the plurality of players and the received plurality of electronic messages indicating bids from the users of the plurality of mobile devices.

Additionally, or alternatively, the instructions can cause the processor, prior to providing the electronic message indicating availability of the auction, to determine whether each user of the plurality of mobile devices and each player of the plurality of players are eligible for participation in the auction. In such cases, the electronic message indicating availability of the auction can be sent to the plurality of mobile devices having eligible users and/or the plurality of gaming systems having eligible players.

For example, the auction prize can comprise a bonus multiplier for an electronic game. In some cases, the instructions can further cause the processor to normalize a value of the auction prize based on an amount of one of the bids. Additionally, or alternatively, the instructions can cause the processor to set an initial price for the auction prize based on a model of previous auction prizes. In another example, the auction can comprise an auction of a jackpot of a game of chance.

According to yet another embodiment a system can comprise a communication network, a gaming host system coupled with the communication network and comprising a processor and a memory coupled with and readable by the processor and storing therein a set of instructions which, when executed by the processor, causes the processor to provide, through the communication network, an electronic message indicating availability of an auction. The system can further comprise a plurality of gaming systems coupled with the communication network, each gaming system of the plurality of gaming systems can comprise a processor and a memory coupled with and readable by the processor and storing therein a set of instructions which, when executed by the processor, causes the processor to execute an electronic game, receive, through the communication network, the electronic message indicating availability of the auction from the gaming host system during execution of the electronic game, provide, to a player of the electronic game, an indication of availability of the auction, receive, from the player of the electronic game, a request to participate in the auction and provide, to the gaming host system, through the communication network, an electronic message indicating participation in the auction by the player.

The instructions stored in the memory of the gaming host system can further cause the processor of the gaming host system to receive, through the communication network, from the plurality of gaming systems, the electronic message indicating participation in the auction by the players of the electronic games executing on the plurality of gaming systems, and initiate the auction.

The instructions stored in the memory of each gaming system can further cause the processor of each gaming system to receive, from the player of the electronic game, an indication of a bid, and provide, to the gaming host system, through the communication network, an electronic message indicating the bid from the player.

The instructions stored in the memory of the gaming host system can further cause the processor of the gaming host system to receive, through the communication network, from the plurality of gaming systems, the electronic messages indicating bids from the players, determine a player placing a highest bid at a close of the auction based on the received plurality of electronic messages indicating bids from the players, and provide an auction prize to the player of the plurality of players placing the highest bid at a close of the auction.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary gaming host system according to one embodiment of the present disclosure.

FIG. 3 is a block diagram illustrating additional details of components of an exemplary gaming system according to one embodiment of the present disclosure.

FIG. 4 is a flowchart illustrating an exemplary process for providing an auction in a gaming venue according to one embodiment of the present disclosure.

FIG. 5 is a flowchart illustrating an exemplary process for providing an auction in a gaming venue according to another embodiment of the present disclosure.

FIG. 6 is a flowchart illustrating an exemplary process for providing an auction in a gaming venue according to another embodiment of the present disclosure.

FIG. 7 is a flowchart illustrating an exemplary process for providing an auction in a gaming venue according to another embodiment of the present disclosure.

### DETAILED DESCRIPTION

Embodiments of the present disclosure are directed to conducting an auction among players and/or visitors in a gaming venue. Players in the casino or other gaming venue can voluntarily participate in the auction, from within the venue, such as through an Electronic Gaming Machine (EGM) or other gaming system they are playing, or from a mobile device connected to the casino or to a gaming device. Various gaming-related features, vouchers, prizes, products, etc. that are associated with the venue can be purchased by auction, among players being present in the casino venue, in real-time.

Through embodiments of the present disclosure, while gaming, much more interaction with other players can be enabled. Players still play their game, perhaps solitarily, but in addition, there is the casino auction system that can trigger an auction any time. It encourages “competition”, amongst interested players by allowing them to bid, through their gaming system, for various auction prizes, in real-time.

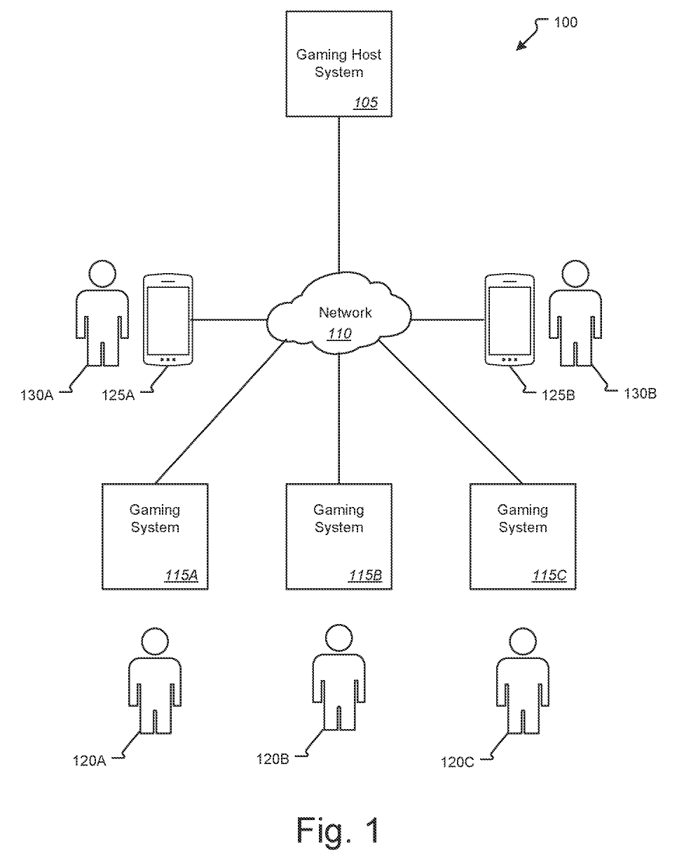

FIG. 1 is a block diagram illustrating an exemplary environment in which embodiments of the present disclosure can be implemented. As illustrated in this example, the environment 100 can comprise a gaming host system 105 coupled with a communications network 110. Generally speaking, the game host system 105 can comprise any one or more servers and/or other computing devices as known in the art and which may be used, for example, by an electronic game design studio. The communications network 110 can comprise any one or more wired and/or wireless, local-area and/or wide-area networks as known in the art including, but not limited to, the Internet.

Also coupled with the communications network 110 can be any number of gaming systems 115A-115C. Generally speaking, each gaming system 115A-115C can comprise, for example, any Electronic Gaming Machine (EGM), kiosk, or similar gaming system as may be found in a casino or other gaming venue. The gaming systems 115A-115C can each execute any of a variety of electronic games including, but not limited to slots, video slots, video poker, keno, etc. to be played by players 120A-120C.

Also coupled with the communications network 110 can be any number of mobile devices 125A-125B when users 130A-130B of those devices are present in the gaming venue. The mobile devices 125A-125B can comprise, for example, smart phones, tablets, smart watches, smart glasses, and/or other mobile device types as known in the art.

As introduced above, and according to embodiments of the present disclosure, the gaming host system 105 can conduct an auction between the players 120A-120C and/or mobile device users 130A-130B through the gaming systems 115A-115C and/or mobile devices 125A-125B. For example, a player 120A can be playing an electronic game at a gaming system 115A. An auction can be triggered by the gaming host system, rewarding the highest bidder with +10 free spins whenever they enter the bonus. Each player 115A-115C at a gaming system 115A-115C can be asked to give their bid within a limited time span, e.g., 5 minutes. Each bidder can be personally tracked by the gaming host system 105, e.g., through a player tracking card, and the winning bidder can be awarded the +10 free spins stored onto their account.

In another example, a player 130A can be present at the gaming venue, connected with their mobile device 125A to the network 110. An auction rewarding the highest bidder with an all-inclusive weekend in the casino hotel can be triggered by the gaming host system 105 which provides a push notification to the mobile device 125A. The player 130A can be logged into their casino or gaming venue account on a mobile app executing on the mobile device 125A and can bid in the auction through the mobile app. Other players 120A-120C, playing at a gaming system 115A-115C, can also be part of this auction. The highest bidder, no matter if from mobile device 125A or gaming system 115A-115C can win the auction reward.

In yet another example, a player can be present at the gaming venue, and can have crypto wallet. The gaming host system can trigger an auction for a newly minted Non-Fungible Token (NFT). Each player who owns a crypto wallet can bid for the NFT with crypto currency, either via mobile device 125A-125B or via a gaming system 115A-115C. The highest bidder wins and can be rewarded with the NFT. The NFT might be a rare collectible that will have a crypto market price for which they can sell it in the crypto market or the NFT might grant the player in-game benefits.

According to one embodiment, when an auction is initiated on a gaming system 115A, the screen or display can scale the game window, e.g., change the resolution of the screen or change the window size dynamically, and have an on-screen dashboard to support the auctions. The gaming system 115A can additionally, or alternatively, insert into game play states in the wrapper level an auction state which the game may not know about, but the wrapper can go into and take over the screen for the auction. In another example, an overlay can be created on top of the game, and independent of the game, which can be activated/deactivated, scaled, repositioned, etc. by the player.

According to one embodiment, an escrow fund can be used for the auction that is paid for by the auction amounts and which can be used to fund the difference in the game paytable when free spins are awarded. Additionally, or alternatively, a second paytable or even a separate “game” can be used which is triggered when the normal bonus is triggered and is paid for by the escrow fund. The fund can be shared between all machines and can be used to subsidize the extra amounts paid out by the gaming systems during the special bonus rounds. In some cases, the auction can be treated as a side wager in the game but is pre-paid for instead of paying for each spin. Additionally, or alternatively, the auction can be used to force a re-trigger in a free game which can be triggered by an external bonus.

According to one embodiment, players participating in an auction can be identified and authenticated using a player authentication, player tracking card, mobile device connected to the network, a crypto wallet, or other means. In other cases, players can be anonymous. In such cases, the player can enter a “gamer tag,” receive a print-out code from the machine, and redeem the code to receive the prize.

According to one embodiment, the auction can comprise a silent auction in which the players provide a secret offer and the person with the highest secret offer wins. In other cases, the auction can comprise a mystery auction, a themed mystery auction, or other type of auction.

According to one embodiment, the auction content or award can include, but is not limited to, electronic gaming features, free spins, bonus triggers, casino event ticket, casino concert tickets, casino table poker tour participation, NFTs, cosmetic NFTs, NFTs with gaming benefits, e.g., to trigger certain game events, or to modify paytable, etc., casino venue-related benefits, casino venue voucher for dinner, shoppable casino brand assets such as T-Shirts, poker case, poker cards, etc., casino venue voucher for a night in the casino resort, voucher for a number of free credits upon the next casino visit, and/or others.

According to one embodiment, player auction eligibility may be subject opt certain criteria. These criteria can include, but are not limited to, being present in the casino or gaming venue, either at a gaming system or through a mobile device, being signed up or registered for auction participation, those actively playing, e.g., placed a bet within the last 30 sec, having paid auction participation eligibility, having previously placed a threshold number of bets to become eligible, etc.

According to one embodiment, the auction can comprise a community bidding bonus. During a triggered community bonus, there can be a window, e.g., a 30 second window, before the bonus starts where an auction begins for a bonus multiplier. Each player may place a bid to win the extra multiplier or may also not participate if they wish. Once the window is over, the highest bidder wins the multiplier. Losing bids can be placed into a linked progressive that could be possibly won by the winner of the community bonus round. In some cases, a restriction may be applied so that only people who participate in the auction are eligible to win the progressive.

According to one embodiment, various auction participation devices may be used by players. These devices can include, but are not limited to, EGMs, Electronic Table Games (ETGs), bar-integrated terminals, mobile devices connected to casino network, televisions within the gaming venue, etc.

According to one embodiment, bidding can include a healthy behavior bonus bid award. In such cases, players showing healthy behavior can be awarded free bid award, encouraging them to continue.

According to one embodiment, the award for an auction can be normalized based on one or more bids placed. For example, the reward is increased based on the third highest bid, making sure that the reward is realistic and appropriate compared to the bid amount.

According to one embodiment, the auction can be conducted using micro (penny) bidding. In such cases, when a player places a bid, starting at a penny, that player pays that penny. The next bidder bids another penny over the previous bid. The bidding only supports a short window, e.g., 30 to 60 seconds, which can be configurable for min/max time by the operator. Every bid costs one penny and all bids for the item are accumulated by costs. Base bid amount can be customized to be more than one penny, e.g., ten cents, one dollar, etc. The auction can also have penny cost increases of bids, but also a static service fee per bid of another amount, e.g., fifty cents a bid, which can be hidden or made obvious.

According to one embodiment, Artificial Intelligence (AI) can be used to set prices of goods. For example, an AI model can be used to adjust initial prices of goods based upon previous goods and categories of goods being auctioned.

According to one embodiment, data such as player monthly spending, time of year, etc. can be used to adjust prices. In some cases, minimum bid increments can be adjusted based upon AI suggestions. Additionally, or alternatively, the gaming venue operator can set or override initial starting prices.

According to one embodiment, the auction can comprise a central spin auction. In random intervals, on a central screen, a bid auction starts on the outcome of universal spin on shared lottery style jackpot. This universal spin can either hit or pass. The reels take a few minutes to stop, one by one. The player with the highest bid wins the outcome of the universal spin. Players can place bids on the reels of the universal reels. From left to right, each reel can be entered into the auction before it stops. Each highest bidder wins one reel and the outcome of the universal spin can then be divided between the reel owners. Remote notification can be provided for universal reels auction in which players receive notifications on their phones, if consented, so they will not miss the opportunity to place their bids on them.

According to one embodiment, notification of auctions can be provided based on subscription. Players can actively subscribe to receive notifications interest for any auctions available. Players can subscribe via email, activate respective notification in their mobile app, turn on in-game notifications, etc.

According to one embodiment, an auction reward can comprise an in-game reward and/or promotional credits. Such rewards can have a time restricted validity or can be made valid for defined games to drive traffic to those games or introduce new games. The rewards can comprise token codes, voucher codes, or can be printed on the ticket printer to be traded in.

According to one embodiment, responsible gaming features can be applied to the auctions. For example, the gaming host system 105 can allow self-exclusion from bidding. Additionally, or alternatively, the gaming host system 105 can allow for setting limits on maximum bidding as well as overall spending limits on auctions.

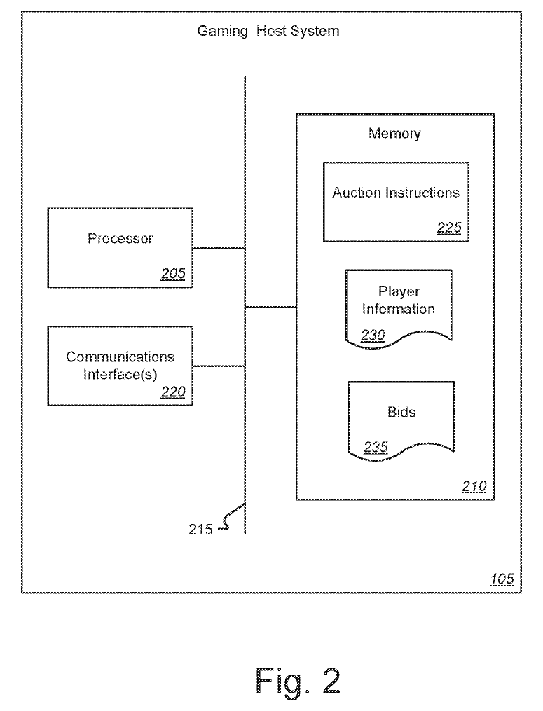

FIG. 2 is a block diagram illustrating additional details of components of an exemplary gaming host system according to one embodiment of the present disclosure. As illustrated in this example, a gaming host system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming host system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, an Ethernet, Bluetooth, WiFi, cellular, and/or other type of wired and/or wireless communications interface. Via the communication interface(s) 220, the gaming host system 105 can communicate with other devices and/or systems through a communications network 115 as described above.

The memory 210 can store therein a set of auction instructions 225 which, when executed by the processor 205, cause the processor 205 to providing an electronic message indicating availability of an auction. The electronic message indicating availability of an auction can be provided through the communications interface(s) 220 to gaming systems 115A-115C and/or mobile devices 125-125B within a gaming venue. In some cases, the auction instructions 225 can further cause the processor 205 to first identify eligible players and/or mobile device users, e.g., based on a set of player information 230.

The auction instructions 225 can further cause the processor 205 to receive, from the plurality of gaming systems 115A-115C and/or mobile devices 125A-125B, through the communications interface(s) 220, an electronic message indicating participation in the auction by a plurality of players 120A-120C of electronic games executing on the plurality of gaming systems 115A-115C and or users 130A-130B of the mobile devices 125A-125B and initiate the auction. In some cases, the auction instructions 225 can further cause the processor 205 to first authenticate players and/or mobile device users, e.g., based on a set of player information 230.

The auction instructions 225 can further cause the processor 205 to receive, from the plurality of gaming systems 115A-115C and/or mobile devices 125A-125B, through the communications interface(s) 220, a plurality of electronic messages indicating bids 235 and determine a player of the plurality of players 120A-120C or mobile device users 130A-130B placing a highest bid at a close of the auction based on the received plurality of electronic messages indicating bids, and provide an auction prize to the player of the plurality of players 120A-120C or mobile device users 130A-130B placing the highest bid at a close of the auction.

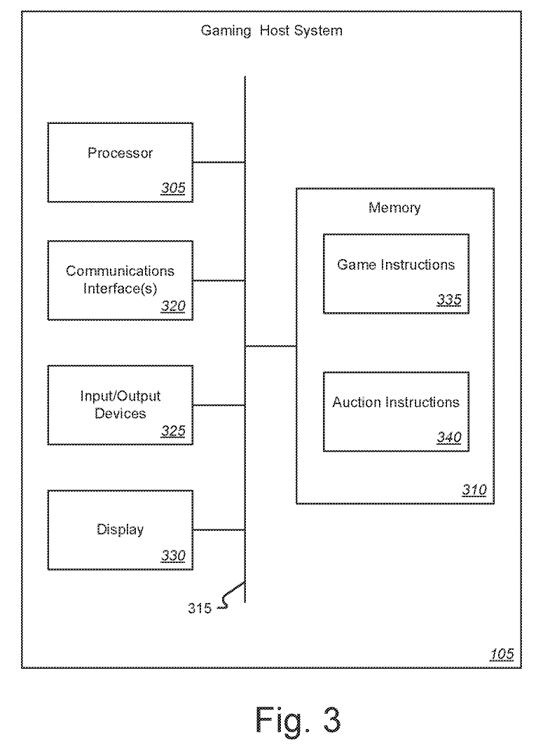

FIG. 3 is a block diagram illustrating additional details of components of an exemplary gaming system according to one embodiment of the present disclosure. As illustrated in this example, a responsible gaming system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, one or more input/output devices 325, and a display 330. The communication interfaces 320 can comprise, for example, an Ethernet, Bluetooth, WiFi, cellular, and/or other type of wired and/or wireless communications interface. The input/output devices 225 can include, but are not limited to, buttons, speakers, a ticket printer, one or more cameras, microphones, etc. The display can comprise a Liquid Crystal Display (LCD), Light Emitting Diode (LED), Organic Light Emitting Diode (OLED), or other type of display.

The memory 310 can store therein a set of game instructions 335 which, when executed by the processor 305, cause the processor 305 to execute an electronic game. The memory can also store therein a set of auction instructions 340 which, when executed by the processor 305, can cause the processor 305 to receive an electronic message indicating availability of the auction from the gaming host system 105 through the communications interface(s) during execution of the electronic game. The auction instructions 340 can further cause the processor 305 to present, e.g., through the display 330, an indication of availability of the auction to the player 120A-120C and receive a request to participate in the auction from the player 120A-120C of the electronic game, e.g., based on the player clicking a link, pressing a button, etc. The auction instructions 340 can further cause the processor 305 to provide to the gaming host system 105through the communications interface(s) an electronic message indicating participation in the auction by the player. Once the auction is initiated, the auction instructions 340 can further cause the processor 305 to receive an indication of a bid from the player 120A-120C and provide a message indicating the bid to the host system 105 through the communications interface(s) 330.

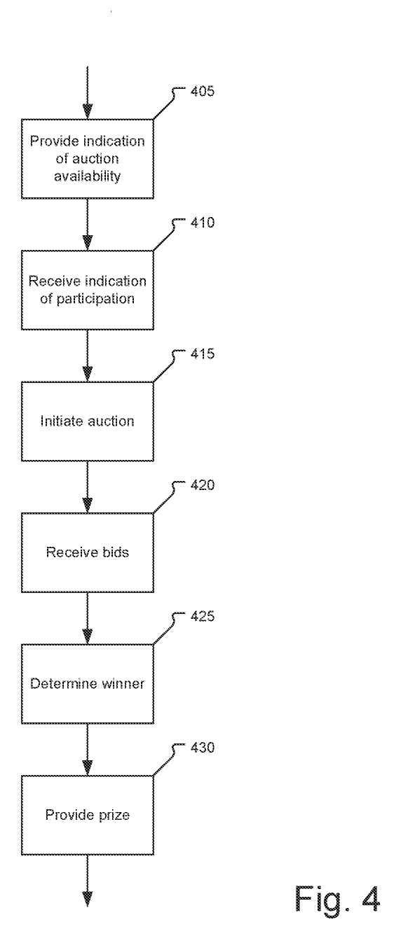

FIG. 4 is a flowchart illustrating an exemplary process for providing an auction in a gaming venue according to one embodiment of the present disclosure. As illustrated in this example, conducting an auction among players 120A-120C and/or visitors 130A-130B in a gaming venue can comprise providing 405 an electronic message indicating availability of an auction. The electronic message indicating availability of an auction can be provided 405 to gaming systems 115A-115C and/or mobile devices 125-125B within a gaming venue.

An electronic message indicating participation in the auction by a plurality of players 120A-120C of electronic games executing on the plurality of gaming systems 115A-115C and or users 130A-130B of the mobile devices 125A-125B can be received 410 from the plurality of gaming systems 115A-115C and/pr mobile devices 125A-125B and the auction can be initiated 415. The auction can comprise a silent auction, a themed mystery auction, or other type of auction.

A plurality of electronic messages indicating bids from the plurality of players can be received 420 from the plurality of gaming systems 115A-115C and/or mobile devices 125A-125B and a player of the plurality of players 120A-120C or mobile device users 130A-130B placing a highest bid at a close of the auction can be determined 425 based on the received plurality of electronic messages indicating bids. An auction prize can be provided 430 to the player of the plurality of players 120A-120C or mobile device users 130A-130B placing the highest bid at a close of the auction.

For example, the auction prize can comprise an electronic game feature, a gaming venue event ticket, a Non-Fungible Token (NFT), a gaming venue-related benefit, or other award. In another example, the auction prize can comprise a bonus multiplier for an electronic game. In some cases, a value of the auction prize can be normalized based on an amount of one of the bids. Additionally, or alternatively, an initial price can be set for the auction prize based on a model of previous auction prizes. In another example, the auction can comprise an auction of a jackpot of a game of chance.

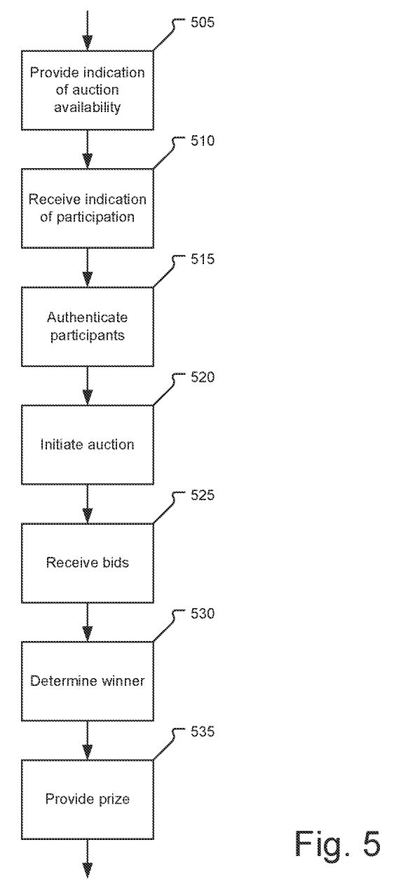

FIG. 5 is a flowchart illustrating an exemplary process for providing an auction in a gaming venue according to another embodiment of the present disclosure. As illustrated in this example, conducting an auction among players 120A-120C and/or visitors 130A-130B in a gaming venue can comprise providing 505 an electronic message indicating availability of an auction. The electronic message indicating availability of an auction can be provided 505 to gaming systems 115A-115C and/or mobile devices 125-125B within a gaming venue.

An electronic message indicating participation in the auction by a plurality of players 120A-120C of electronic games executing on the plurality of gaming systems 115A-115C and or users 130A-130B of the mobile devices 125A-125B can be received 510 from the plurality of gaming systems 115A-115C and/or mobile devices 125A-125B. As illustrated in this example, each player 115A-115C and/or mobile device user 125A-125B wishing to participate in the auction can be authenticated 515 and the auction can be initiated 520 for the authenticated players 115A-115C and/or mobile device users 125A-125B.

A plurality of electronic messages indicating bids from the plurality of players can be received 525 from the plurality of gaming systems 115A-115C and/or mobile devices 125A-125B and a player of the plurality of players 120A-120C or mobile device users 130A-130B placing a highest bid at a close of the auction can be determined 530 based on the received plurality of electronic messages indicating bids. An auction prize can be provided 525 to the player of the plurality of players 120A-120C or mobile device users 130A-130B placing the highest bid at a close of the auction.

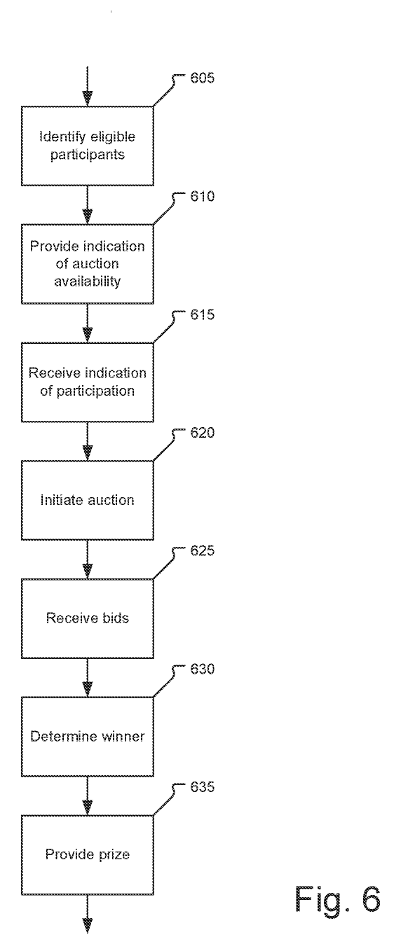

FIG. 6 is a flowchart illustrating an exemplary process for providing an auction in a gaming venue according to another embodiment of the present disclosure. As illustrated in this example, conducting an auction among players 120A-120C and/or visitors 130A-130B in a gaming venue can comprise identifying 605 eligible players 120A-120 and/or mobile device users 130A-130B, e.g., based on a profile for each, and providing 610 an electronic message indicating availability of an auction. The electronic message indicating availability of an auction can be provided 610 to gaming systems 115A-115C and/or mobile devices 125-125B within a gaming venue.

An electronic message indicating participation in the auction by a plurality of players 120A-120C of electronic games executing on the plurality of gaming systems 115A-115C and or users 130A-130B of the mobile devices 125A-125B can be received 615 from the plurality of gaming systems 115A-115C and/or mobile devices 125A-125B and the auction can be initiated 620.

A plurality of electronic messages indicating bids from the plurality of players can be received 625 from the plurality of gaming systems 115A-115C and/or mobile devices 125A-125B and a player of the plurality of players 120A-120C or mobile device users 130A-130B placing a highest bid at a close of the auction can be determined 630 based on the received plurality of electronic messages indicating bids. An auction prize can be provided 635 to the player of the plurality of players 120A-120C or mobile device users 130A-130B placing the highest bid at a close of the auction.

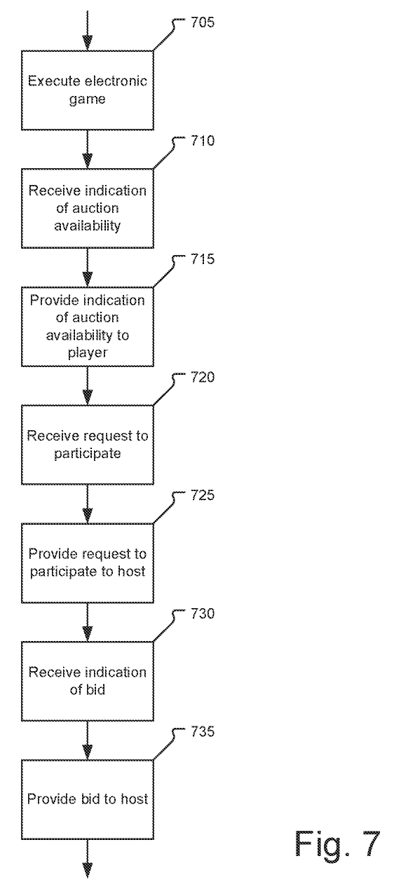

FIG. 7 is a flowchart illustrating an exemplary process for providing an auction in a gaming venue according to another embodiment of the present disclosure. More specifically, this example illustrates a process as may be performed by a gaming system 115A-115C as described above. As illustrated in this example, conducting the auction can comprise executing 705 and electronic game and receiving 710 the electronic message indicating availability of the auction from the gaming host system during execution of the electronic game. An indication of availability of the auction can be provided 715 to the player 120A-120C and a request to participate in the auction can be received 720 from the player 120A-120C of the electronic game. An electronic message indicating participation in the auction by the player can be provided 725 to the gaming host system 105. Once the auction is initiated, an indication of a bid can be received 730 from the player 120A-120C and provided 735 to the host system 105.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for providing an auction in a gaming venue, the method comprising:
providing, by a processor of a gaming host system, to a plurality of gaming systems in the gaming venue, an electronic message indicating availability of an auction;
receiving, by the processor of the gaming host system, from the plurality of gaming systems, an electronic message indicating participation in the auction by a plurality of players of electronic games executing on the plurality of gaming systems;
initiating, by the processor of the gaming host system, the auction;
receiving, by the processor of the gaming host system, from the plurality of gaming systems, a plurality of electronic messages indicating bids from the plurality of players;
determining, by the processor of the gaming host system, a player of the plurality of players placing a highest bid at a close of the auction based on the received plurality of electronic messages indicating bids from the plurality of players; and
providing, by the processor of the gaming host system, an auction prize to the player of the plurality of players placing the highest bid at a close of the auction.

2. The method of claim 1, further comprising:
providing, by the processor of the gaming host system, electronic message indicating availability of an auction to a plurality of mobile devices within the gaming venue;
receiving, by the processor of the gaming host system, from the plurality of mobile devices, an electronic message indicating participation in the auction by users of the plurality of mobile devices; and
receiving, by the processor of the gaming host system, from the plurality of mobile devices, a plurality of electronic messages indicating bids from the users of the plurality of mobile devices, wherein determining the player of the plurality of players placing the highest bid at the close of the auction based on the received plurality of electronic messages indicating bids from the plurality of players further comprises determining the player of the plurality of players or user of the plurality of mobile devices placing the highest bid at the close of the auction based on the received plurality of electronic messages indicating bids from the plurality of players and the received plurality of electronic messages indicating bids from the users of the plurality of mobile devices.

3. The method of claim 1, further comprising authenticating each player of the plurality of players.

4. The method of claim 1, wherein the auction comprises a silent auction.

5. The method of claim 1, wherein the auction comprises a themed mystery auction.

6. The method of claim 1, wherein the auction prize comprises an electronic game feature.

7. The method of claim 1, wherein the auction prize comprises gaming venue event ticket.

8. The method of claim 1, wherein the auction prize comprises a Non-Fungible Token (NFT).

9. The method of claim 1, wherein the auction prize comprises a gaming venue-related benefit.

10. A system comprising:
a communication interface;
a processor coupled with the communication interface; and
a memory coupled with and readable by the processor and storing therein a set of instructions which, when executed by the processor, causes the processor to:
provide, to a plurality of mobile devices within a gaming venue, an electronic message indicating availability of an auction;
receive, from the plurality of mobile devices, an electronic message indicating participation in the auction by a plurality of user of the plurality of mobile devices;
initiate the auction;
receive, from the plurality of mobile devices, a plurality of electronic messages indicating bids from the users of the mobile devices;
determine a user of the plurality of users placing a highest bid at a close of the auction based on the received plurality of electronic messages indicating bids from the users of the plurality of mobile devices; and
provide an auction prize to the user of the plurality of users placing the highest bid at a close of the auction.

11. The system of claim 10, wherein the instructions further cause the processor to:
provide the electronic message indicating availability of an auction to a plurality of gaming systems within the gaming venue;
receive, from the plurality of gaming systems, an electronic message indicating participation in the auction by players of electronic games on the plurality of gaming systems; and
receive, from the plurality of gaming systems, a plurality of electronic messages indicating bids from the players of the electronic games executing on the plurality of gaming systems, wherein determining the user of the plurality of users placing the highest bid at the close of the auction based on the received plurality of electronic messages indicating bids from the users of the plurality of mobile devices further comprises determining the player of the plurality of players or user of the plurality of mobile devices placing the highest bid at the close of the auction based on the received plurality of electronic messages indicating bids from the plurality of players and the received plurality of electronic messages indicating bids from the users of the plurality of mobile devices.

12. The system of claim 11, wherein the instructions further cause the processor, prior to providing the electronic message indicating availability of the auction, to determine whether each user of the plurality of mobile devices and each player of the plurality of players are eligible for participation in the auction and wherein the electronic message indicating availability of the auction is sent to the plurality of mobile devices having eligible users and the plurality of gaming systems having eligible players.

13. The system of claim 11, wherein the auction prize comprises a bonus multiplier for an electronic game.

14. The system of claim 10, wherein the instructions further cause the processor to normalize a value of the auction prize based on an amount of one of the bids.

15. The system of claim 10, wherein the instructions further cause the processor to set an initial price for the auction prize based on a model of previous auction prizes.

16. The system of claim 10, wherein the auction comprises an auction of a jackpot of a game of chance.

17. A system comprising:
a communication network;
a gaming host system coupled with the communication network and comprising a processor and a memory coupled with and readable by the processor and storing therein a set of instructions which, when executed by the processor, causes the processor to:
provide, through the communication network, an electronic message indicating availability of an auction;
a plurality of gaming systems coupled with the communication network, each gaming system of the plurality of gaming systems comprising a processor and a memory coupled with and readable by the processor and storing therein a set of instructions which, when executed by the processor, causes the processor to:
execute an electronic game;
receive, through the communication network, the electronic message indicating availability of the auction from the gaming host system during execution of the electronic game;
provide, to a player of the electronic game, an indication of availability of the auction;
receive, from the player of the electronic game, a request to participate in the auction; and
provide, to the gaming host system, through the communication network, an electronic message indicating participation in the auction by the player.

18. The system of claim 17, wherein the instructions stored in the memory of the gaming host system further cause the processor of the gaming host system to:
receive, through the communication network, from the plurality of gaming systems, the electronic message indicating participation in the auction by the players of the electronic games executing on the plurality of gaming systems; and
initiate the auction.

19. The system of claim 18, wherein the instructions stored in the memory of each gaming system further cause the processor of each gaming system to:
receive, from the player of the electronic game, an indication of a bid; and
provide, to the gaming host system, through the communication network, an electronic message indicating the bid from the player.

20. The system of claim 19, wherein the instructions stored in the memory of the gaming host system further cause the processor of the gaming host system to:
receive, through the communication network, from the plurality of gaming systems, the electronic messages indicating bids from the players;
determine a player placing a highest bid at a close of the auction based on the received plurality of electronic messages indicating bids from the players; and
provide an auction prize to the player of the plurality of players placing the highest bid at a close of the auction.
